(19) United States
(12) Patent Application Publication
(10) Pub. No.: US 2025/0037025 A1
(43) Pub. Date: Jan. 30, 2025

(54) METHOD FOR TRAINING A MACHINE LEARNING MODEL FOR CONTROLLING A ROBOT TO MANIPULATE AN OBJECT

(71) Applicant: Robert Bosch GmbH, Stuttgart (DE)

(72) Inventors: Alexander Qualmann, Schoenaich (DE); Anh Vien Ngo, Nehren (DE); Miroslav Gabriel, Muenchen (DE); Philipp Christian Schillinger, Renningen (DE); Yushi Liu, Kornwestheim (DE)

(21) Appl. No.: 18/772,768

(22) Filed: Jul. 15, 2024

(30) Foreign Application Priority Data
Jul. 27, 2023 (DE) 10 2023 207 208.4

(51) Int. Cl. G06N 20/00; G05B 19/4155

(52) U.S. Cl. CPC G06N 20/00; G05B 19/4155; G05B 2219/40269; G05B 2219/50391

(57) ABSTRACT

A method for training a machine learning model for controlling a robot. The method includes, for each training data element of a set of training data elements, wherein each training data element comprises training input information about the location of surface points of a respective object and one or more possible approach directions of the robot for manipulating the object, ascertaining, via the machine learning model, one or more contact points, ascertaining, via the machine learning model, weighting parameter values of a mixture distribution of spherical distributions for the approach direction, and training the machine learning model to reduce a loss that contains an approach-direction loss component per training data element and per possible approach direction.

### CROSS REFERENCE

The present application claims the benefit under 35 U.S.C. § 119 of German Patent Application No. DE 10 2023 207 208.4 filed on Jul. 27, 2023, which is expressly incorporated herein by reference in its entirety.

### FIELD

The present invention relates to methods for training a machine learning model for controlling a robot to manipulate an object.

### BACKGROUND INFORMATION

Picking up (i.e., gripping) an object is an important problem in robotics. Recent research uses machine learning methods to make model-free gripping of unknown objects in unstructured environments possible. Many approaches focus on solving the gripping problem with three degrees of freedom (DoF) for parallel grippers and single suction grippers and output a gripping position along with a success metric. Although this simplifies the gripping problem, it requires assumptions about the orientation of the gripper, which, for example, leads to a restriction of the top-down gripping execution for parallel grippers (i.e., the approach direction) and additionally restricts the application of these approaches to specific gripper types.

Approaches to automatically controlling a robot to pick up (or generally manipulate) a robot that allow flexibility with regard to the approach direction of the gripper are therefore desirable.

The paper De Cao, N. and Aziz, W., “The power spherical distribution,” 2020, arXiv preprint arXiv: 2006.04437, hereinafter referred to as Reference 1, describes the power spherical distribution.

### SUMMARY

According to various embodiments of the present invention, a method for training a machine learning model for controlling a robot (to manipulate, in particular pick up, an object) is provided, comprising:
For each training data element of a set of training data elements, wherein each training data element comprises training input information (e.g., a 3D point cloud or a depth image (including the associated intrinsic camera parameters) or information derived therefrom, such as a 3D voxel normal grid) about the location of surface points of a respective object and one or more possible approach directions of the robot for manipulating the object,
   Ascertaining, via the machine learning model, one or more contact points on the surface of the object for manipulating the object by means of an end effector (e.g., gripper) of the robot,
   Ascertaining, via the machine learning model, weighting parameter values (i.e., mixture parameter values ω) of a mixture distribution of spherical distributions (i.e., for example, a mixed power spherical distribution) for the approach direction for manipulating the object, wherein each of the spherical distributions is assigned a respective end-effector orientation angle (and the weighting parameter value for the spherical distribution is a rating of an approach direction corresponding to the end-effector orientation angle); and
Training the machine learning model to reduce a loss that contains, per training data element and per possible approach direction, an approach-direction loss component that decreases with increasing probability that the mixture distribution provides the possible approach direction, wherein the direction parameter (i.e., the mean direction vector) of each of the spherical distributions is set according to the end-effector orientation angle assigned to the spherical distribution (i.e., the direction vector is set such that it corresponds to the assigned end-effector orientation angle and is located in a plane whose surface normal coincides with the direction of a basis vector that specifies the direction between two contact points (specifically when gripping) and can be determined as ground truth from the assigned basis vectors from the training data element).

The set of training data elements is typically a batch of several training data elements (but, in the extreme case, a single training data element).

The method of the present invention described above makes it possible to train a machine learning model to densely predict gripping contact point pairs (e.g., together with values for gripper opening width) and gripping qualities for several gripping orientations (and thus approach directions) per contact point pair. The dense prediction of gripping points with several orientations (where appropriate, orientations and/or contact points that are close to one another, hence “dense”) makes it possible to more successfully grip objects even under additional constraints (e.g., reachability of the robot): The dense prediction of several orientations per contact point pair of the parallel grippers makes the approach very flexible in situations that are restricted to particular gripper orientations, e.g., when removing an object from a container with narrow gripping spaces and possible limitations of the kinematic reachability by the robot. Here, additional gripper orientations can make gripping objects possible despite these limitations and can increase the number of grippable objects in these scenarios.

With the approach of the present invention described above, gripping processes can also be predicted for objects that are not (completely) visible, which is important in scenarios with only one camera for parallel gripping (for example, when removing an object from a container): The prediction of contact point pairs is also possible if the contact points are not (both) visible image points, which makes gripping possible at points that are not visible in the camera image. This is particularly important in gripping scenarios with only one view, such as when removing an object from a container, where the camera view is typically restricted to a view from above due to the container geometry and only a single-view camera image, in which the gripping object is only partially captured from one or more sides depending on the object geometry, is thus available as an input for the machine learning model. However, for parallel grippers, it is necessary to predict contact points on two opposite sides of an object geometry, which usually cannot be captured from a single camera view. The prediction of gripping points even on non-visible parts of the object is therefore crucial in order to make it possible to successfully grip a large number of objects in such a single-view scenario with limited spatial accessibility (such as when removing objects from a container).

The prediction of a collision-free grip (gripping pose (including approach direction) plus gripper opening width) makes it possible to directly execute the predicted grip without the need for additional collision checks.

Various exemplary embodiments of the present invention are specified below.

Exemplary embodiment 1 is a method for training a machine learning model for controlling a robot, as described above.

Exemplary embodiment 2 is a method according to exemplary embodiment 1, wherein each training data element contains at least one direction vector between contact points (as ground truth) (e.g., two points corresponding to the two points at which the end effector grips the object in a respective grip), and wherein the loss furthermore contains a basis-vector loss component for at least one of the ascertained contact points per training data element, which basis-vector loss component decreases with increasing probability that a spherical distribution ascertained by the machine learning model for the basis vectors of an ascertained contact point matches the spherical distribution of the basis vectors assigned to an ascertained contact point and contained in the training data element.

The machine learning model is thus also trained to correctly predict the direction vector between the contact points (herein also referred to as the basis vector).

Exemplary embodiment 3 is a method according to exemplary embodiment 1 or 2, wherein each training data element comprises one or more contact points (as ground truth), and wherein the method comprises ascertaining, for each training data element and for each ascertained contact point, an associated partner contact point (i.e., a total of one contact point pair, in particular for gripping with a parallel gripper, wherein the partner contact point for a contact point results from the opening width in the direction of the basis vector from the contact point), and wherein the loss furthermore comprises a width loss component per training data element and per ascertained contact point, which width loss component decreases with decreasing distance of the ascertained associated partner contact point to the one or more partner contact points of the training data element.

The machine learning model is thus trained to correctly predict pairs of contact points.

Exemplary embodiment 4 is a method according to one of exemplary embodiments 1 to 3, wherein each training data element (as ground truth) comprises at least one contact-point quality rating, and the method comprises ascertaining, via the machine learning model, a quality rating for each ascertained contact point, and wherein the loss furthermore comprises a quality loss component per training data element and per ascertained contact point, which quality loss component increases with increasing difference between the quality rating ascertained for the ascertained contact point and a contact-point quality rating (e.g., quality ratings of one or more contact points neighboring the ascertained contact point, for which the training data element comprises a contact-point quality rating) that the training data element comprises for an associated contact point.

The machine learning model is thus trained to correctly predict qualities of contact points (and thus, for example, of grips).

Exemplary embodiment 5 is a method according to one of exemplary embodiments 1 to 4, wherein each training data element (as ground truth) comprises at least one (ground truth) position of a contact point on the surface of an object to be manipulated and at least one position of a reference point (e.g., gripping center) of the end effector, and the method comprises classifying, via the machine learning model, spatial regions into spatial regions with contact point and without contact point as well as with reference point and without reference point, and wherein the loss furthermore comprises, per training data element, a classification loss of the classification as a contact-point reference-point loss component. The classification may (as is usual for classification tasks) include the output of soft values, which are used to ascertain the classification loss. The machine learning model is thus trained to predict a suitable position and orientation of the end effector.

Exemplary embodiment 6 is a method for controlling a robot to manipulate an object to be manipulated, comprising:
Supplying information about the location of surface points of the object to be manipulated to a machine learning model that is trained, in response to the supply of information about the location of surface points of an object, to output contact points on the surface of the object for manipulating the object by means of the end effector of the robot and weighting parameter values of a mixture distribution of spherical distributions for the approach direction for manipulating the object, wherein each of the spherical distributions is assigned a respective end-effector orientation angle;
Selecting, by comparison with a specified threshold value (e.g., 0.9 for a weighting parameter value range from 0 to 1), a weighting parameter value (and, where appropriate, by comparison of any quality values likewise output by the machine learning model with a specified quality threshold value) that is above the specified threshold value, from among the weighting parameter values (and, where appropriate, quality values) output by the machine learning model in response to the supplied information; and Controlling the robot to manipulate the object to be manipulated by moving the end effector of the robot toward the object in the approach direction given by the end-effector orientation angle assigned to the spherical distribution weighted in the mixture distribution by the selected weighting parameter value. (e.g., by moving the end effector of the robot toward the object in the end effector position and orientation that are given by contact points output by the machine learning model, the associated output basis vectors and the approach direction (and, where appropriate, by a gripper opening width output by the machine learning model (in order to avoid a collision between gripper fingers and object)).

In this way, the robot can be controlled without collision.

Exemplary embodiment 7 is a method according to exemplary embodiment 6, wherein the machine learning model is trained according to one of exemplary embodiments 1 to 5.

Exemplary embodiment 8 is a robot control apparatus configured to carry out a method according to one of exemplary embodiments 1 to 7.

Exemplary embodiment 9 is a computer program comprising instructions that, when executed by a processor, cause the processor to carry out a method according to one of exemplary embodiments 1 to 7.

Exemplary embodiment 10 is a computer-readable medium storing instructions that, when executed by a processor, cause the processor to carry out a method according to one of exemplary embodiments 1 to 7.

In the figures, similar reference signs generally refer to the same parts throughout the various views. The figures are not necessarily true to scale, with emphasis instead generally being placed on the representation of the principles of the present invention. In the following description, various aspects of the present invention are described with reference to the figures.

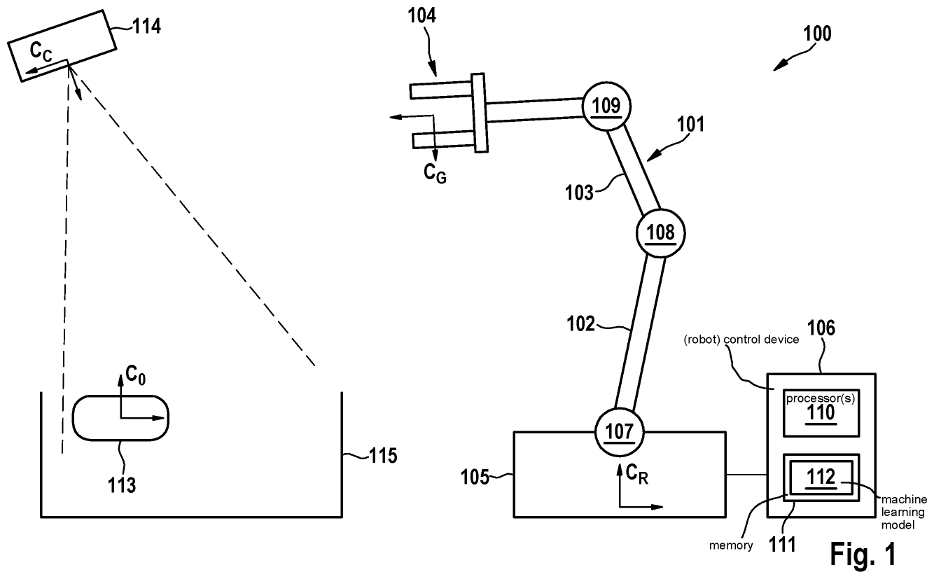

FIG. 1 shows a robot with an end effector (e.g., gripper), camera and controller as well as an object (e.g., for gripping) and a container, according to an example embodiment of the present invention.

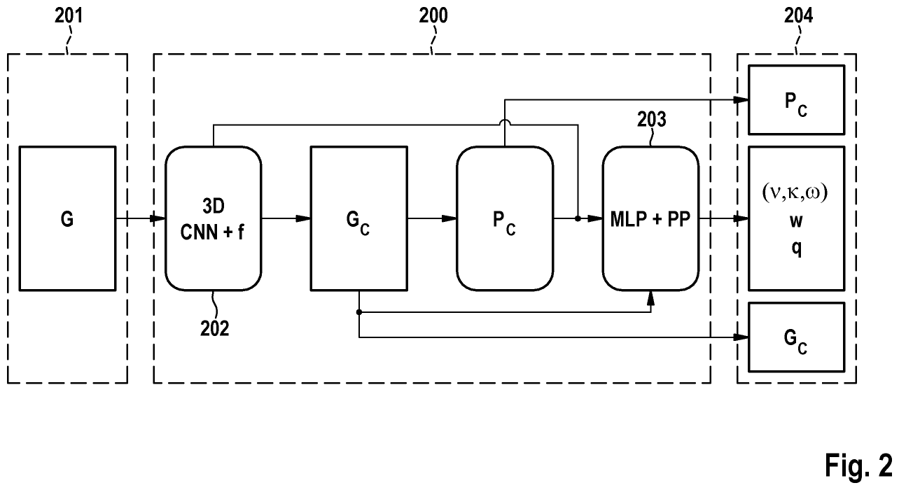

FIG. 2 illustrates a machine learning model for predicting gripping poses, associated gripper opening widths, collision probabilities, and gripping qualities, according to an example embodiment of the present invention.

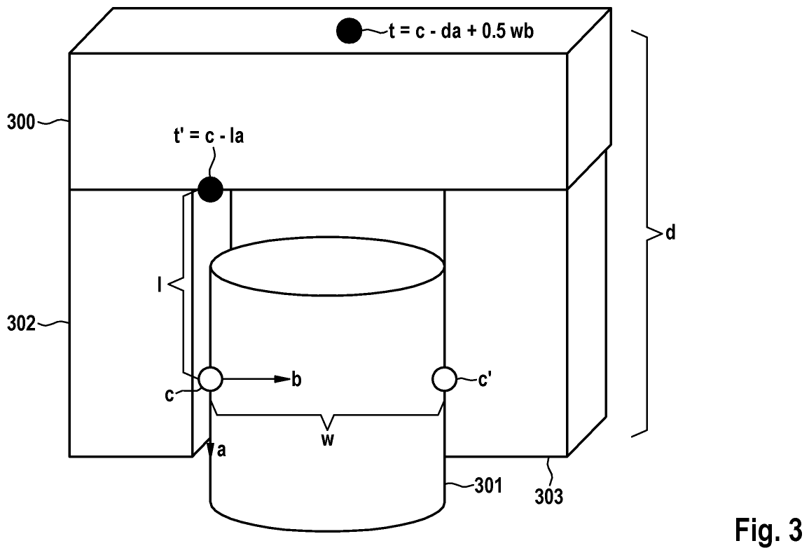

FIG. 3 shows a gripper gripping an object.

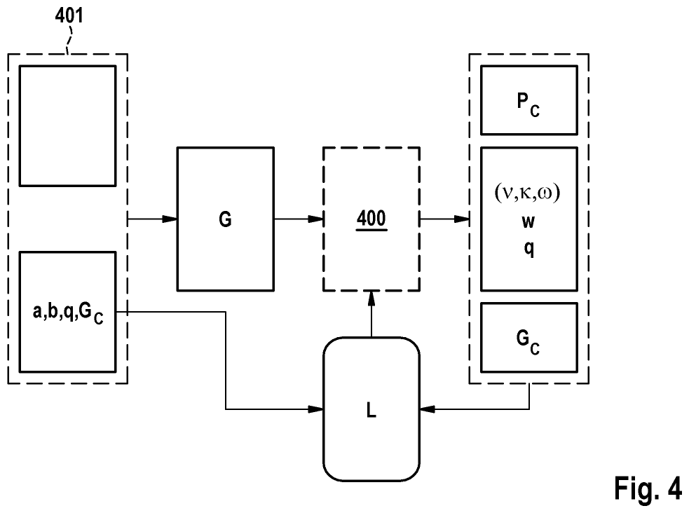

FIG. 4 illustrates the training of the machine learning model according to the present invention e.g., as described with reference to FIG. 2).

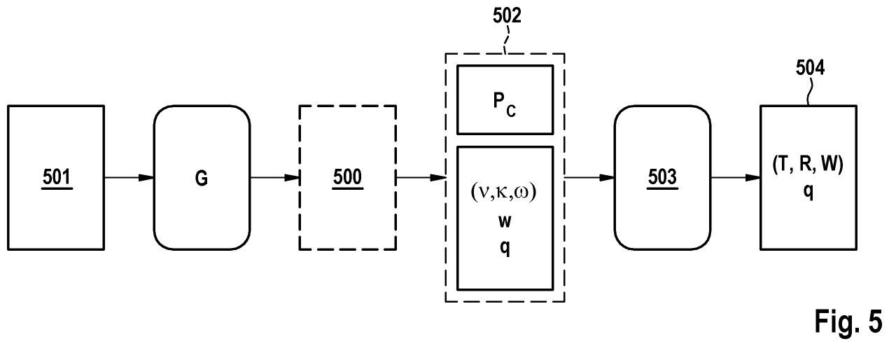

FIG. 5 illustrates the inference by means of the trained machine learning model according to the present invention (e.g., as described with reference to FIG. 2).

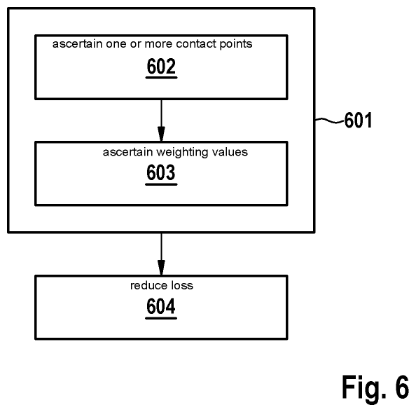

FIG. 6 shows a flowchart representing a method for training a machine learning model for controlling a robot to manipulate an object according to an example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

FIG. 1 shows a robot 100.

The robot 100 includes a robot arm 101, for example an industrial robot arm for handling or assembling a work piece (or one or more other objects). This serves only as an example here, and the approach described below is not limited to the execution of a gripping process with a robot arm but can also be used for other robot kinematics (e.g., parallel kinematic robots). The robot arm 101 includes movable arm elements 102, 103, 104 and a base (or support) 105, which supports the arm elements 102, 103, 104. The term “movable arm elements” refers to the movable components of the robot arm 101, the actuation of which makes physical interaction with the environment possible, for example in order to perform a task. For control, the robot 100 includes a (robot) control device 106, which is designed to implement the interaction with the environment according to a control program.

The last arm element 104 (which is farthest away from the support 105) of the arm elements 102, 103, 104 is also referred to as the end effector 104 and may include one or more tools, such as a welding torch, a gripping tool, a painting device, or the like.

The other arm elements 102, 103 (located closer to the support 105) can form a positioning apparatus so that the robot arm 101 with the end effector 104 at its end is provided together with the end effector 104. The robot arm 101 is a mechanical arm (possibly with a tool at its end).

The robot arm 101 can include joint elements 107, 108, 109 which connect the arm elements 102, 103, 104 to one another and to the support 105. A joint element 107, 108, 109 can have one or more joints, which can each provide a rotatable movement (i.e., rotational movement) and/or translational movement (i.e., displacement) for associated arm elements relative to one another. The movement of the arm elements 102, 103, 104 can be initiated by means of actuators controlled by the control device 106.

The term “actuator” may be understood as a component that is designed to bring about a mechanism or process in response to its drive. The actuator can implement instructions (called activation) generated by the control device 106 as mechanical movements. In response to its activation, the actuator, for example an electromechanical converter, can be designed to convert electrical energy into mechanical energy.

The term “control device” can be understood as any type of logic-implementing entity (including one or more computers) that may, for example, include a circuit and/or processor that is capable of executing software, firmware or a combination thereof stored in a storage medium, and that can issue instructions, for example to an actuator in the present example. The control device can be configured for example by program code (e.g., software) to control the operation of a system, in the present example a robot.

In the present example, the control device 106 includes one or more processors 110 and a memory 111 that stores code and data, on the basis of which the processor 110 controls the robot arm 101. According to various embodiments, the control device 106 controls the robot arm 101 based on a machine learning model 112 stored in the memory 111.

According to various embodiments, the machine learning model 112 is designed and trained to make it possible for the robot 100 to recognize manipulation poses on one or more objects 113 where the robot 100 can pick up (or otherwise interact with, e.g., paint) the object(s) 113.

The robot 100 may, for example, be equipped with one or more cameras 114 that enable it to record images of its working space. The camera 114 is fastened for example to the robot arm 101 so that the robot can capture images of the object 113 from various perspectives by moving its robot arm 101. However, the camera 114 can also be fixedly mounted in a robot cell, as shown in FIG. 1, in order to capture the objects to be gripped.

According to various embodiments, the machine learning model 112 is a neural network and the control device 106 supplies the neural network with input data on the basis of the one or more digital images (depth images with optional color images and intrinsic camera parameter values or a point cloud with optional color images) of an object 113, and the neural network ascertains suitable poses for the end effector 104 (hereinafter assumed to be a gripper by way of example; accordingly mentioned are “grips,” which the machine learning model ascertains). The machine learning model can also ascertain quality values for such grips. The quality value that the neural network outputs for a grip is, for example, a probability value that specifies an expected probability that gripping (or manipulating in general) with the respective grip will be successful. In addition, the machine learning model can also ascertain collision values for such grips. The collision value that the neural network outputs for a grip is, for example, a probability value that specifies an expected probability that gripping (or manipulating in general) with the respective gripper is possible without collision with other objects, the box or the environment. The probability values can be taken into account in subsequent processing in order ultimately to control the robot to carry out the gripping (or manipulation in general).

According to various embodiments, a procedure (in particular an architecture) is provided for the end-to-end training (and associated inference, i.e., prediction) of a machine learning model (e.g., the machine learning model 112) so that the machine learning model can predict grips (or their collision probability values and quality values) for an end effector 104, such as a gripper with six degrees of freedom (for the gripping pose), specifically a parallel gripper, wherein it considers several possible orientations.

For example, the machine learning model is trained such that it can densely predict contact point pairs (on the surface of the object to be gripped) together with the gripper opening width, a collision probability value and a gripping quality value for several gripper orientations per contact point pair on the basis of a point cloud for a gripping scenario (such as for removing objects from a container). In particular, the prediction of dense contact points and several gripping orientations per contact point pair provides a large solution space that makes it possible to find successful grips (gripping pose plus gripper opening width) even if additional constraints (such as reachability of the robot) prevent the execution of several grips.

The procedure described herein is not limited to a particular design of parallel grippers. The machine learning model is, for example, a neural network, such as a convolutional neural network, e.g., with a U-net architecture, and may also be a 3D convolutional neural network (3D-CNN) and/or have or contain a 3D U-net architecture. The input of the machine learning model consists, for example, of image data (for a gripping scenario, i.e., a control situation, in which an object is to be gripped), which are represented in the form of a 3D voxel grid (e.g., by representing the surface normal vectors per voxel).

The machine learning model contains, for example, a 3D convolutional neural network (e.g., with 3D U-net architecture) that maps each voxel feature (e.g., each normal vector per voxel) of a 3D voxel grid to an output of a 3D voxel grid with the same resolution, wherein, for each voxel, the probability is output as to whether the voxel includes a contact point, a reference point, or no contact point or reference point.

According to various embodiments, the machine learning model is trained by means of a loss function based on the power spherical distribution or a mixed power spherical distribution. However, it is also possible to use a loss function based on a different spherical distribution (e.g., the von Mises-Fisher distribution). Accordingly, the mixture distribution is not necessarily a mixed power spherical distribution but can also be a mixture of different spherical distributions.

FIG. 2 illustrates a machine learning model 200 for predicting gripping poses, associated gripper opening widths, and gripping qualities. The machine learning model 200 corresponds, for example, to the machine learning model 112 and is for example a neural network.

The input 201 of the machine learning model 200 consists of a normal grid G, i.e., a 3D voxel grid (i.e., a division of the considered 3D space into voxels), in which each voxel contains a surface normal of the closest point on the surface of an object (i.e., for example, the object 113 to be gripped) to the voxel center. The normal grid is, for example, obtained by preprocessing from a 3D point cloud (e.g., ascertained from a camera image with depth information and intrinsic camera parameter values).

The normal grid G is first processed by a 3D convolutional neural network (3D-CNN) 202 of the machine learning model 200, which comprises several encoder layers, each of which can contain a gate function f (in addition to a convolutional layer). The gate function is optional and can be used to improve the performance in the case of a sparse contact point prediction, such as in gripping scenarios for removing an object from a container in which the objects to be gripped occupy only a small portion of the camera field of view. Here, the gate function serves as a weighting function of the output features of each layer in order to deactivate unimportant features.

The result of the 3D-CNN is a voxel grid G_{C}. Each voxel of the grid is represented by a 3D vector (l₁, l₂, l₃), where l₁, l₂, l₃ are confidence values that a voxel is an “invalid point,” a “contact point,” or a “gripping center” (or corresponds to or contains such a point/center since it covers an entire spatial region). This marks each voxel as an “invalid point,” a “contact point,” or a “gripping center” (depending on which confidence value is the highest).

FIG. 3 shows a gripper 300 gripping an object 301.

The gripper 300 grips the object 301 at two contact points, i.e., at a contact point pair (c, c′), which are spaced apart by the gripper opening width w (distance between the gripper fingers 302, 303 of the gripper) in the direction of a “basis” vector b. The orientation of the gripper 300 in the gripping pose with which it grips the object 301 by a vector a (which points in the direction in which the gripping fingers 302, 303 extend; it can be understood as an approach direction since the gripper is typically moved in this direction, at least shortly before gripping).

The gripper has a gripper center t and the point t′=c−la is referred to as the gripping center (or also reference point on the gripper) (where l is the position of the contact point c along the (here left) gripper finger that touches it).

Defining the gripping center t′ near the contact point makes it possible for the gripping center t′ and the contact points to be in the same receptive field, which supports the training of the 3D-CNN.

The machine learning model 200 then samples contact points P_{C} from the voxels marked with “contact point” in G_{C}, i.e., for each of several (where appropriate, all) of the voxels marked with “contact point,” it samples one or more contact points within the voxel (e.g., randomly within the voxel or by subdividing the voxel).

An MLP 203 then receives, as an input, multi-resolution features of the contact points that are obtained by concatenating features provided by the layers (for different resolutions) of the 3D-CNN network (i.e., from the feature maps output by the encoder layers of the 3D-CNN network). Since the encoder layers provide the features per voxel and not per contact point, interpolation (e.g., trilinear interpolation) for example is used to ascertain the feature values of the contact points.

The MLP 203 comprises several layers and the last layer of the MLP 203 outputs, for each of the sampled contact points, the parameters of a mixed power spherical (PS) distribution ν, κ and ω, the opening width of the gripper w, and the quality q. Here, ν (direction parameter) and κ (spread parameter) are the parameters of a power spherical distribution (as described in Reference 1 but denoted there by μ and κ). The power spherical distribution by ν and κ is (for the respective contact point and a respective approach direction a) a prediction (or estimate) of the machine learning model for the distribution of the basis vector b. The power spherical distribution can be understood as a kind of distribution of the basis vector b on a hypersphere in 3D space (as a counterpart to a Gaussian distribution). The parameter ν then specifies the mean (or optimally predicted) basis vector, and κ is a measure of the spread around this mean basis vector (the lower κ is, the more uncertain the prediction).

The vector ω comprises nr entries, where each entry ωᵢ is the coefficient of a power spherical distribution in a mixed power spherical distribution. The mixed power spherical distribution is a distribution of the approach vector a, which can be located at one of nᵣ angles (e.g., sampled from or defined in [0, π]) in the plane perpendicular to ν. The mixed power spherical distribution is a sum of power spherical distributions (one for each of the nᵣ angles), which are each weighted by the respective ωᵢ i.e., the sum thus weighted is the mixed power spherical distribution for the approach vector. Each of the power spherical distributions summed therein comprises, as a parameter, the approach direction corresponding to the respective angle and κ (see also the formula for the loss term Lₐ below).

Each weight ωᵢ rates the permissibility of the respective approach vector (in the range [0;1]: in the case of certain collision ωᵢ=0, certainly without collision ωᵢ=1). Thus, ω is both a parameter of the mixed power spherical distribution (in the training) and at the same time a measure or a rating (in the inference) for the permissibility of a grip (collision-free or not; in the inference, the value is between 0 and 1 and specifies the probability of a collision-free grip, i.e., by comparison with a threshold value, it can be determined whether the grip is rated as a collision-free or collision-prone grip) for a particular angle (i.e., approach vector). The mixed power spherical distribution can be considered as a counterpart to a Gaussian mixture distribution for the 3D case.

The parameter q is the rating of the quality of the respective gripping contact point, i.e., a measure of how likely a stable grip is at this contact point. All nᵣ grips have the same quality rating q since the stability of the grip does not depend on the gripping direction or the approach vector).

The approach can also be used with other spherical distributions (e.g., the von Mises-Fisher distribution).

In order to merge the information of the MLP 203 with the 3D-CNN 202 again and to improve the prediction for a respective contact point, the values for the output quality q and output values for the collision probability ωᵢ are adapted to the location of the contact points within the respective voxel in a subsequent post-processing (PP) step. For this purpose, contact point interpolation scores are determined for the sampled contact points by means of trilinear interpolation and are multiplied by the respective quality values q of the associated contact points. In addition, the actual positions of the gripping centers are ascertained for the respective contact points and corresponding gripping center interpolation scores are determined by trilinear interpolation of the gripping center grid and are multiplied by the respective weighting factors ωᵢ of the power spherical distribution, which represent the collision freedom for the different approach angles of a contact point.

The output 204 of the machine learning model 200 consists of the sampled contact points P_{C}, the parameters ν, κ and ω, the opening width of the gripper w, and the quality q for each of the contact points as well as the information from G_{C} as to which voxels were marked as “gripping center” and as “contact point.”

FIG. 4 illustrates the training of the machine learning model 400 (which corresponds to the machine learning model 200).

Each training data element 401 of the training data set contains a training input for a control situation, from which a normal grid G can be generated by preprocessing (e.g., from a depth image with intrinsic camera parameter values or a 3D point cloud), as well as ground truth data (i.e., labels or target outputs). The ground truth data contain (a number k of) possible grips for the control situation scene, each represented as a contact point \hat{P}_{C}, a basis vector \hat{b}, an approach vector â, a gripper width ŵ, and a gripping quality \hat{q}. The training data can also contain gripper parameters, such as the finger length l and the gripper height d (e.g., from the gripper top side to the finger end).

The training data set can be generated e.g. by means of a simulation environment. This requires the simulation of the gripped objects, camera and additional components (e.g., a container when picking containers) as well as the selection of several gripping candidates, and the rating of their gripping quality (e.g., with a physics simulator).

The machine learning model 400 to be trained now operates as described with reference to FIG. 2. During the training, interpolated ratings of the gripping centers ωᵢ are calculated from G_{C}. For this purpose, the nᵣ gripping centers, which are calculated by means of the nᵣ approach vectors per sampled contact point, are inserted into G_{C} in order to ascertain the confidence ratings ωᵢ of the gripping centers by interpolation (from the l₃). Interpolated confidence ratings of the gripping quality q of the contact points are ascertained in the same way by inserting the sampled contact points and interpolation (of the l₂).

In order to calculate the loss contribution for each sampled contact point P_{C}, the set N(P_{C}) of contact points P_{C} which are present within a radius r around Pc and are specified in the ground truth of the respective training data element is ascertained:

$$N ( {P}_{C} ) = \{ {P}_{C} \vert {‖ \hat{{P}_{C}} - \hat{{P}_{C}} ‖}_{2} < r \} , \vert N ( {P}_{C} ) \vert = {\sum }_{i = 1}^{k} {𝟙}_{N ( {P}_{C} )} ( \hat{{P}_{{C}_{i}}} )$$

The sampled contact points are divided into two groups on the basis of the respective N(P_{C}): Points in the set C have at least one ground truth neighbor (i.e., N(P_{C})>1). Points in the set C̅ have no neighbor in the contact point set of the ground truth of the respective training data element:

$$C = \{ {P}_{C} \vert N ( {P}_{C} ) > 0 \} , \overline{C} = \{ {P}_{C} \vert N ( {P}_{C} ) = 0 \}$$

As explained with reference to FIG. 2, for each sampled contact point and approach vector, the machine learning model 400 outputs the parameters ν and κ, which are the parameters of a power spherical (PS) distribution for the basis vector b of the contact point. In order to form the distribution of the approach vectors a and to calculate the loss for the gripper width w, an estimation of a ground truth \hat{ν} is carried out using the following equation:

$$\hat{ν} = \frac{\hat{{b}^{′}}}{{‖ \hat{{b}^{′}} ‖}_{2}} \hat{{b}^{′}} = {\sum }_{i = 1}^{k} \hat{{b}_{i}} {𝟙}_{N ( {P}_{C} )} ( \hat{{P}_{{C}_{i}}} )$$

The distribution of the approach directions at each contact point is modeled as a mixed power spherical (PS) distribution, which is parameterized by T(\hat{ν}), κ and ω. T is a transformation which generates nᵣ approach directions T(\hat{ν})ⱼ for \hat{ν} (according to the specified angular steps).

The contact point Pc belonging to a contact point pair (in addition to the contact point P_{C}) (also called the partner contact point belonging to the contact point) can be calculated from \hat{ν} and P_{C} and with the following equation:

$${Pc}^{′} = Pc + \hat{ν} w .$$

As described with reference to FIG. 2, the machine learning model 400 also predicts the gripping centers in the voxel grid G_{C} during the training. The gripping centers and the contact points are also used as an input for the following loss function.

According to various embodiments, the loss for a training data element is the sum of five loss terms:

$$L = β {L}_{b} + α {L}_{a} + {L}_{w} + θ {L}_{q} + γ {L}_{{G}_{C}}$$

where α, β, γ and θ are the weights of the individual (loss terms) loss components.

These loss terms are described in more detail below.
1. Loss of basis vectors L_{b}: negative logarithmic probability that the basis vectors of the ground truth are sampled from the power spherical distribution parameterized by (ν, κ), which the machine learning model 400 provides for the training data element

$${L}_{b} = \frac{1}{\vert C \vert} {\sum }_{{P}_{C} ∈ C} \frac{1}{\vert N ( {P}_{C} ) \vert} {\sum }_{i = 1}^{k} - log ( PS ( \hat{{b}_{i}} \vert ν , κ ) ) {𝟙}_{N ( {P}_{C} )} ( \hat{{P}_{{C}_{i}}} )$$

2. Approach loss Lₐ: negative logarithmic probability that the approach vectors of the ground truth are sampled from a mixture of power spherical distributions parameterized by (T(\hat{ν}), κ, ω)

$${L}_{a} = \frac{1}{\vert C \vert} {\sum }_{{P}_{C} ∈ C} \frac{1}{\vert N ( {P}_{C} ) \vert} {\sum }_{i = 1}^{k} L ( \hat{{a}_{i}} ) {𝟙}_{N ( {P}_{C} )} ( \hat{{P}_{{C}_{i}}} ) ,$$

$$L ( \hat{{a}_{i}} ) = {\sum }_{j = 1}^{{n}_{r}} {ω}_{j} PS ( \hat{{a}_{i}} \vert {T ( \hat{ν} )}_{j} , κ )$$

3. Width loss of the width L_{w}: distance between P_{C′} and \hat{P}_{C′}

$${L}_{a} = \frac{1}{\vert C \vert} {\sum }_{{P}_{C} ∈ C} \frac{1}{\vert N ( {P}_{C} ) \vert} {\sum }_{i = 1}^{k} D ( {P}_{{C}^{′}} , \hat{{P}_{{C}_{i}^{′}}} ) {𝟙}_{N ( {P}_{C} )} ( \hat{{P}_{{C}_{i}}} )$$

Here, D can be any geometric distance function, e.g., the Euclidean distance.
4. Quality loss L_{q}: difference between q and \hat{q}

$${L}_{q} = \frac{1}{\vert C \vert} {\sum }_{{P}_{C} ∈ C} \frac{1}{\vert N ( {P}_{C} ) \vert} {\sum }_{i = 1}^{k} D ( q , \hat{{q}_{i}} ) {𝟙}_{N ( {P}_{C} )} ( \hat{{P}_{{C}_{i}}} ) + \frac{1}{\vert C \vert} {\sum }_{{P}_{C} ∈ \hat{C}} D ( q , 0 )$$

Here, D can be any distance function, e.g., the squared Euclidean distance.
5. Loss of the gripping center grid and the contact point grid L_{G}_{_{C}}: This loss can be any classification loss (e.g., focal loss).

For the training of the machine learning model 400, the parameters of the machine learning model 400, including the parameters of the 3D-CNN 202 and of the MLP 203, are updated by backpropagation (with respect to the loss L, e.g., summed or averaged over a batch of training data elements and the respectively sampled contact points).

FIG. 5 illustrates the inference by means of the trained machine learning model 500 (e.g., as described with reference to FIG. 2).

The input 501 for the inference consists of a 3D point cloud (e.g., obtained from a depth image with intrinsic camera parameters are from a single viewing angle), which is transformed into the normal grid G.

The machine learning model 400 now operates as described with reference to FIG. 2. During the inference, interpolated ratings of the gripping centers ωᵢ are calculated from G_{C}. For this purpose, the nᵣ gripping centers, which are calculated by means of the nᵣ approach vectors per sampled contact point, are inserted into G_{C} in order to ascertain the confidence ratings ωᵢ of the gripping centers by interpolation (from the l₃). Interpolated confidence ratings of the gripping quality q of the contact points are ascertained in the same way by inserting the sampled contact points and interpolation (of the l₂).

The output 502 of the machine learning model 500 consists of the contact points P_{C} and the parameters of the mixed power spherical distribution ν, κ and ω as well as the gripper width w and the gripping quality q for each contact point.

By means of a transformation 503, the output 502 can be transformed into a 6-DoF robot gripping pose representation (which can be executed directly by a robot controller, for example). For this purpose, the gripper center t and the gripper orientation matrix R are needed. The relationship between the gripper center t and the contact point c is given by:

$$t = c - a d + 0.5 w b$$

The orientation matrix R can be calculated from the approach vector a and the basis vector b as follows:

$$R = ( b , a \times b , a )$$

Here, d is the gripper height and b corresponds to ν, which is part of the output 502 of the machine learning model. As in the training, during the inference, the transformation T(⋅) is applied to each ν in order to generate nᵣ approach vectors for each contact point. The entries of ω (i.e., the permissibility rating for each approach vector) can be converted into a binary rating by setting a threshold value, in order to filter out collision-free grips.

The final result 504 is a list of collision-free grips, which are each specified by a translation vector t, a rotation matrix R, a gripper width w, and the gripping quality q.

Alternatively, in addition to the grips output, the permissibility rating ωᵢ for each grip (without conversion into a binary rating) can also be output in 504, e.g., in order to use the probability, represented thereby, of a collision-free grip in a downstream robot movement planning.

In summary, according to various embodiments, a method is provided as shown in FIG. 6.

FIG. 6 shows a flowchart 600 representing a method for training a machine learning model for controlling a robot to manipulate an object according to one embodiment.

In 601, for each training data element of a set of training data elements, wherein each training data element comprises training input information (e.g., a point cloud or a depth image with intrinsic camera parameter values or information derived therefrom, such as a 3D voxel normal grid) about the location of surface points of a respective object and one or more possible approach directions of the robot, e.g., including the associated gripping quality (or the probability of a successful grip) for manipulating the object,
in 602, the machine learning model ascertains one or more contact points on the surface of the object for manipulating the object by means of an end effector (e.g., gripper) of the robot,
in 603, the machine learning model ascertains weighting parameter values (i.e., mixture parameter values ω) of a mixture distribution of spherical distributions (i.e., for example, a mixed power spherical distribution) for the approach direction for manipulating the object. In the process, each of the spherical distributions is assigned a respective end-effector orientation angle. The weighting parameter value for the spherical distribution can be seen as a rating of an approach direction corresponding to the end-effector orientation angle. According to various embodiments, the machine learning model also outputs the contact point grid and the gripping center grid.

In 604, the machine learning model is to reduce a loss that contains, per training data element and per possible approach direction, an approach-direction loss component that decreases with increasing probability that the mixture distribution provides the possible approach direction, wherein the direction parameter (i.e., mean direction vector) of each of the spherical distributions is set according to the end-effector orientation angle assigned to the spherical distribution (i.e., the direction vector is set such that it corresponds to the assigned end-effector orientation angle and is located in a plane whose surface normal coincides with the direction of a basis vector that specifies the direction between two contact points (specifically when gripping) and can be determined as ground truth from the assigned basis vectors from the training data element). The training can take place according to a conventional procedure for training a machine learning model (i.e., for example, is a neural network or contains such a neural network (or also several such neural networks)), typically backpropagation.

The procedure described with reference to FIG. 6 can be used in connection with software for controlling robot grippers, e.g., for robot applications for removing objects from one or more containers. Here, it makes it possible to predict collision-free gripping candidates with information about gripper position, gripper orientation, and gripper opening width as well as a respective gripping quality, e.g., in the form of an expected probability of a successful grip. The output information can be used for further post-processing steps, for example for planning robot paths, in order ultimately to perform gripping operations in a robot application.

The grips that the training data elements contain are each, for example, represented by a contact point (between object and gripping finger), basis vector (which describes the direction between two contact points of a grip), approach vector of the grip (which describes the approach direction perpendicular to the basis vector), gripper opening width (which describes the distance between two fingers of a parallel gripper), and the associated gripping quality (which describes the probability of a successful grip).

The spherical distribution at a contact point (e.g., for a basis vector, which specifies the direction between two contact points, or for an approach vector, which specifies a direction perpendicular to the basis vector when gripping) is for example determined by means of a set, assigned to the contact point, of contact points and the associated directions (e.g., basis vector and approach vectors) of a training data element from a ground truth data set).

The machine learning model also ascertains for example parameters of a spherical distribution (e.g., distribution parameter values ν and κ of a power spherical distribution) for the basis vectors (which describe the direction between two contact point pairs of a grip) for manipulating the object.

The loss may comprise further loss components (loss for basis vectors, approach vectors, gripper opening width, gripping quality, gripping contact point/and gripping center). The machine learning model can thus, for example, be trained to reduce a loss as a weighted sum of a loss for the basis vectors (described by the parameter values ν and κ of a power spherical distribution), a loss for the approach vectors (described by the values w of a mixture distribution of different power spherical distributions for different approach vectors per contact point), a loss for the gripper opening width (described by the distance of the contact points of a contact point pair), a loss for the gripping quality (described by the probability of a successful grip), and a loss for the contact points and gripping centers.

The method in FIG. 6 can be carried out by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The method is therefore in particular computer-implemented according to various embodiments.

After the training, the machine learning model can be applied to sensor data which are determined by at least one sensor. For example, after the training, the machine learning model is used to generate a control signal for a robot by supplying it with sensor data with respect to the robot and/or its environment.

Various embodiments can receive and use time series of sensor data from various sensors, such as video, radar, lidar, ultrasound, motion, heat imaging, etc. Sensor data can be measured or also simulated for periods of time. Embodiments can be used to train a machine learning system and to control a robot, e.g., autonomously by robot manipulators, in order to achieve various manipulation tasks in different scenarios. In particular, embodiments are applicable to the control and monitoring of the execution of manipulation tasks, for example in assembly lines. They can, for example, be seamlessly integrated with a traditional GUI for a control process.

What is claimed is:

1. A method for training a machine learning model for controlling a robot, comprising the following steps:
for each training data element of a set of training data elements, wherein each training data element includes training input information about a location of surface points of a respective object and one or more possible approach directions of the robot for manipulating the object:
ascertaining, via the machine learning model, one or more contact points on a surface of the object for manipulating the object using an end effector of the robot, and
ascertaining, via the machine learning model, weighting parameter values of a mixture distribution of spherical distributions for the approach direction for manipulating the object, wherein each of the spherical distributions is assigned a respective end-effector orientation angle; and
training the machine learning model to reduce a loss that contains, per training data element and per approach direction, an approach-direction loss component that decreases with increasing probability that the mixture distribution provides the approach direction, wherein the direction parameter of each of the spherical distributions is set according to the end-effector orientation angle assigned to the spherical distribution.

2. The method according to claim 1, wherein each training data element contains at least one direction vector between contact points, and wherein the loss furthermore contains, per training data element, for at least one of the ascertained contact points, a basis-vector loss component that decreases with increasing probability that a spherical distribution ascertained by the machine learning model for basis vectors of an ascertained contact point matches the spherical distribution of basis vectors assigned to an ascertained contact point and contained in the training data element.

3. The method according to claim 1, wherein each training data element includes one or more contact points, including an associated gripper opening width and an associated basis vector which describes the direction of the associated contact point pair for each contact point, and wherein the method further comprises:
ascertaining, for each training data element and for each ascertained contact point, an associated partner contact point, and wherein the loss furthermore includes, per training data element and per ascertained contact point, a width loss component that decreases with decreasing distance of the ascertained associated partner contact point to the one or more associated partner contact points of the training data element.

4. The method according to claim 1, wherein each training data element includes at least one contact-point quality rating, and the method further comprises:
ascertaining, via the machine learning model, a quality rating for each ascertained contact point, and wherein the loss further includes, per training data element and per ascertained contact point, a quality loss component that increases with increasing difference between the quality rating ascertained for the ascertained contact point and a contact-point quality rating that the training data element includes for an associated contact point.

5. The method according to claim 1, wherein each training data element includes at least one ground truth position of a contact point on the surface of an object to be manipulated and at least one position of a reference point of the end effector, and the method comprises further comprising:
classifying, via the machine learning model, spatial regions into spatial regions with contact point and without contact point and with reference point and without reference point, and wherein the loss further includes, per training data element, a classification loss of the classification as a contact-point reference-point loss component.

6. A method for controlling a robot for manipulating an object to be manipulated, comprising the following steps:
supplying information about a location of surface points of the object to be manipulated to a machine learning model that is trained, in response to the supply of information about the location of surface points of an object, to output contact points on a surface of the object for manipulating the object using an end effector of the robot and weighting parameter values of a mixture distribution of spherical distributions for an approach direction for manipulating the object, wherein each of the spherical distributions is assigned a respective end-effector orientation angle;
selecting, by comparison with a specified threshold value, a weighting parameter value that is above the specified threshold value, from among the weighting parameter values output by the machine learning model in response to the supplied information; and
controlling the robot to manipulate the object to be manipulated by moving the end effector of the robot toward the object in the approach direction given by the end-effector orientation angle assigned to the spherical distribution weighted in the mixture distribution by the selected weighting parameter value.

7. The method according to claim 6, wherein the machine learning model is trained by:
for each training data element of a set of training data elements, wherein each training data element includes training input information about a location of surface points of a respective object and one or more possible approach directions of the robot for manipulating the respective object:
ascertaining, via the machine learning model, one or more contact points on the surface of the respective object for manipulating the respective object using an end effector of the robot, and
ascertaining, via the machine learning model, weighting parameter values of a mixture distribution of spherical distributions for the approach direction for manipulating the respective object, wherein each of the spherical distributions is assigned a respective end-effector orientation angle; and
training the machine learning model to reduce a loss that contains, per training data element and per approach direction, an approach-direction loss component that decreases with increasing probability that the mixture distribution provides the approach direction, wherein the direction parameter of each of the spherical distributions is set according to the end-effector orientation angle assigned to the spherical distribution.

8. A robot control apparatus configured to control a robot for manipulating an object to be manipulated, the robot control apparatus configured to:
supply information about a location of surface points of the object to be manipulated to a machine learning model that is trained, in response to the supply of information about the location of surface points of an object, to output contact points on the surface of the object for manipulating the object using an end effector of the robot and weighting parameter values of a mixture distribution of spherical distributions for an approach direction for manipulating the object, wherein each of the spherical distributions is assigned a respective end-effector orientation angle;
select, by comparison with a specified threshold value, a weighting parameter value that is above the specified threshold value, from among the weighting parameter values output by the machine learning model in response to the supplied information; and
control the robot to manipulate the object to be manipulated by moving the end effector of the robot toward the object in the approach direction given by the end-effector orientation angle assigned to the spherical distribution weighted in the mixture distribution by the selected weighting parameter value.

9. A non-transitory computer-readable medium on which are stored instructions for training a machine learning model for controlling a robot, the instructions, when executed by one or more processors, causing the one or more processors to perform the following steps:
for each training data element of a set of training data elements, wherein each training data element includes training input information about a location of surface points of a respective object and one or more possible approach directions of the robot for manipulating the object:
ascertaining, via the machine learning model, one or more contact points on a surface of the object for manipulating the object using an end effector of the robot, and
ascertaining, via the machine learning model, weighting parameter values of a mixture distribution of spherical distributions for the approach direction for manipulating the object, wherein each of the spherical distributions is assigned a respective end-effector orientation angle; and
training the machine learning model to reduce a loss that contains, per training data element and per approach direction, an approach-direction loss component that decreases with increasing probability that the mixture distribution provides the approach direction, wherein the direction parameter of each of the spherical distributions is set according to the end-effector orientation angle assigned to the spherical distribution.
